(19) United States
(12) Patent Application Publication
(10) Pub. No.: US 2017/0275896 A1
(43) Pub. Date: Sep. 28, 2017

(54) Grout Spreader

(71) Applicant: Christopher Valliant, Bloomington, IN (US)

(72) Inventor: Christopher Valliant, Bloomington, IN (US)

(21) Appl. No.: 15/469,793

(22) Filed: Mar. 27, 2017

Related U.S. Application Data
(60) Provisional application No. 62/313,195, filed on Mar. 25, 2016.

(51) Int. Cl. E04F 21/24; B05C 5/00; B05C 11/04; E04B 1/66

(52) U.S. Cl. CPC E04F 21/248; E04B 1/66; B05C 5/00; B05C 11/04

(57) ABSTRACT

An apparatus and method for spreading grout configured to apply and spread grout, sealant, and other similar materials.

### CROSS REFERENCE TO RELATED APPLICATION

The present application claims the benefit of U.S. Provisional Patent Application No. 62/313,195, entitled “Grout Spreader,” to Christopher Valliant, filed Mar. 25, 2016, which is hereby incorporated by reference in its entirety.

### FIELD OF THE DISCLOSURE

The present application relates generally to a sealing device and, more particularly, to a powered device configured to apply and spread grout, sealant, and other similar materials.

### BACKGROUND OF THE DISCLOSURE

One of the more laborious and time-consuming tasks in construction and home improvement is grouting, which refers to a process in which the spaces or gaps between stones or tiles on a surface are filled with a grout mixture or other sealant to seal spaces or gaps between the stones or tiles, secure the position of the tiles, create a more uniform surface, and/or enhance the aesthetic qualities of the surface. Traditionally, grouting is accomplished manually through a number of steps including: pouring a grout mixture or sealant (e.g., cement) onto an ungrouted, tiled surface; using a hand tool such as a trowel to spread the grout mixture such that the grout mixture fills the gaps in the tiled surface; allowing the grout to dry; and cleaning excess grout from the tiled surface.

Manually spreading the grout to fill the empty spaces is a particularly labor-intensive step of a tiling process, and often requires the tiler to remain on his or her hands and knees for extended periods of time, causing strain on the knees, back, shoulders, and arms. Spreading grout on a vertical surface, such as a wall, can be even more difficult because the tiler must work with less grout and must work more quickly to spread the grout into the empty spaces before the grout slides down the vertical surface.

### SUMMARY OF THE DISCLOSURE

The present disclosure relates to an apparatus and method of spreading grout. The grout spreader includes a base, a grout container in communication with the base that provides grout to the base, a plurality of blades that are positioned to distribute grout from the grout container, and a drive assembly coupled to the plurality of blades. At least one of the plurality of blades has a length, in which the ratio of the length to a maximum width of the grout spreader is greater than 1 to 6.

According to another aspect of the present disclosure, a grout spreader includes a base, a grout container in communication with the base that provides grout to the base, and means for pressurizing grout provided to the base, a plurality of blades that are positioned to distribute grout from the grout container, and a drive assembly coupled to the plurality of blades.

According to another aspect of the present disclosure, the grout spreader includes a base and a grout container in communication with the base that provides grout to the base in a direction transverse to vertical, a plurality of blades that are positioned to distribute grout from the grout container, and a drive assembly coupled to the plurality of blades.

According to another aspect of the present disclosure, a grout spreader includes a base, a grout container in communication with the base that provides grout to the base, a plurality of blades that are positioned to distribute grout from the grout container, a drive assembly coupled to the plurality of blades, and at least one handle that is adapted to be gripped by a user to control movement of the grout spreader. The handle has a grip axis adapted to be positioned between a thumb and fingers of a user grasping the handle. The grip axis is adapted to extend in a medial lateral direction relative to a palm of a user grasping the handle and is positioned within a distance less than the maximum width of the base.

In another aspect of the present disclosure, the method for spreading grout on a vertical wall includes the steps of providing a grout spreader that includes a base, a grout container in communication with the base, a plurality of blades positioned to distribute the grout form the grout container, and a drive assembly coupled to the plurality of blades. The method further comprises placing at least one of the plurality of blades against a vertical wall that has a plurality of tiles and then rotating at least one of the plurality of blades to distribute grout into the gaps between the plurality of tiles.

### BRIEF DESCRIPTION OF THE DRAWINGS

FIG. 1 is a perspective view of a grout spreader of the present disclosure including a grout container connected to a base that supports a drive assembly;

FIG. 2 is a bottom view showing an interior of the base of the grout spreader of FIG. 1 which includes a plurality of wipers;

FIG. 3 is a cross sectional view of the spring-loaded rod and plate that forces grout out of the grout container;

FIG. 4 is a perspective view of a grout spreader blade smoothing grout in a gap between tiles on a horizontal surface;

FIG. 5 is a perspective view of a grout spreader blade smoothing grout in a gap between tiles on a vertical wall;

FIG. 6 is a top view of a grout spreader where a grip axis of a first handle is transverse to a grip axis of a second handle coupled to the drive assembly;

FIG. 7 is a top view of a grout spreader where a grip axis of a first handle is parallel to a grip axis of a second handle coupled to the drive assembly; and

FIG. 8 is a top view of a grout spreader where the grout in the grout container is pressurized by a volume of pressurized air.

FIG. 9 is a flow chart illustrating a method of spreading grout.

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

The embodiments of the invention described herein are not intended to be exhaustive or to limit the invention to precise forms disclosed. Rather, the embodiments selected for description have been chosen to enable one skilled in the art to practice the invention.

### DETAILED DESCRIPTION OF THE DRAWINGS

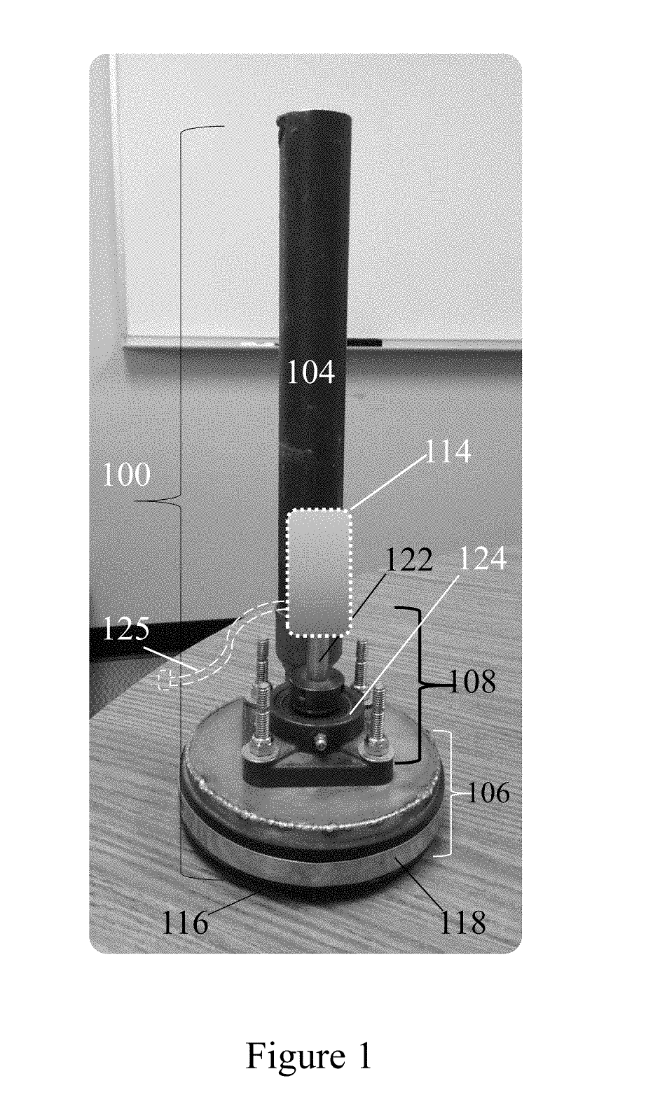

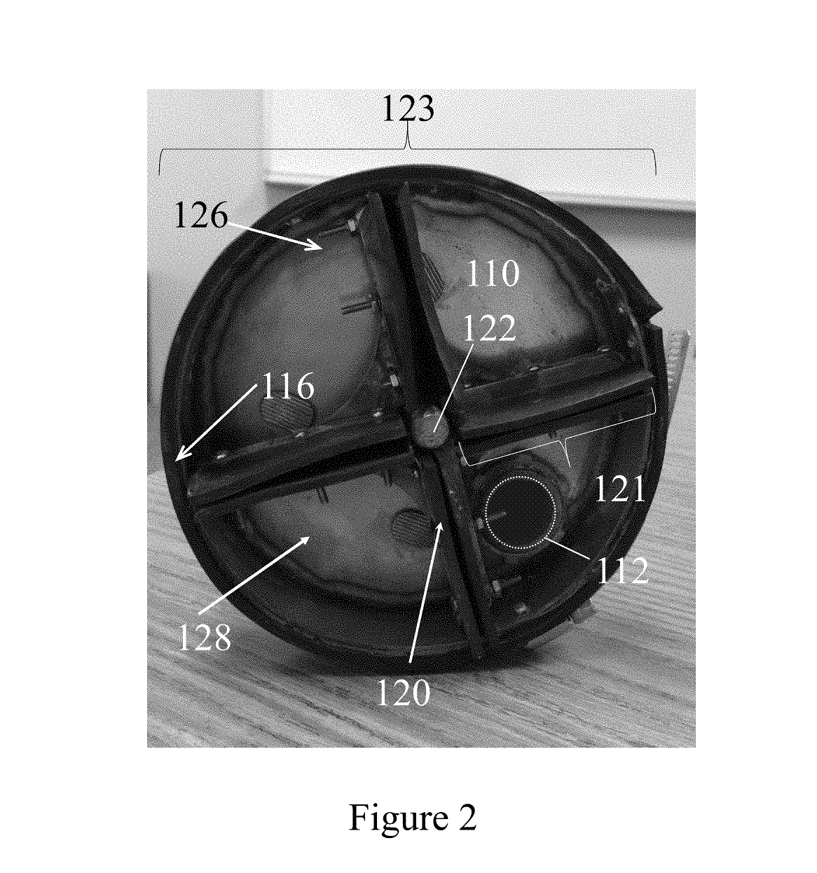

As depicted in FIGS. 1 and 2, a grout spreader 100 includes a grout container 104 configured to receive and contain bulk grout, a base 106, and a drive assembly 108. As shown in FIG. 1, grout container 104 of grout spreader 100 is connected to base 106 such that grout container 104 delivers grout to base 106 to be applied and spread on a desired surface. In the embodiment depicted in FIGS. 1 and 2, base 106 defines a circle and includes a top wall 110 with an opening 112 for receiving grout container 104 and also supports a motor 114 for operating drive assembly 108. In other embodiments, base 106 may be defined by any number of other shapes such as an oval, square, etc. In one embodiment, motor 114 takes the form of a handheld drill (not depicted); however, in other embodiments, motor 114 may be connected to and supported by base 106.

Referring to FIG. 2, an interior 128 of base 106 is generally surrounded by an outer wall 116, and interior 128 forms an enclosed delivery area 126 where grout, received through opening 112 from grout container 104, can be spread onto a desired surface. In the embodiment depicted in FIG. 1, outer wall 116 may be comprised of a polymeric material, such as rubber, and is secured to an external surface of base 106 by a fastener 118 (e.g., metal hose clamp, crimped member, bolts, etc.). A plurality of wipers or blades 120 extend down from the underside of top wall 110.

In one embodiment, plurality of blades 120 extend radially outward to outer wall 116 to be rotated by drive assembly 108. In other embodiments, the plurality of blades 120 may be horizontally, vertically, or diagonally oriented in any number of ways and drive assembly 108 may be operatively coupled to maneuver plurality of blades 120 in various ways (i.e. move blades 120 linearly up and down, vibrate, etc.). In one embodiment, plurality of blades 120 may be oriented in an alternating pattern of perpendicular (90 degrees relative to base 106) and angled, 45 degree positions. In other embodiments, plurality of blades 120 may be oriented in a combination of positions ranging from 45 degrees to 90 degrees (not depicted). In other embodiments, plurality of blades 120 may all be oriented in a perpendicular position (depicted in FIG. 2) or in angled positions (not depicted). Plurality of blades 120 may be comprised of a polymeric material (e.g., rubber) and, in the embodiment depicted in FIGS. 1 and 2, are rotated about a vertical axis by a shaft 122 of drive assembly 108 which is supported by a bearing 124 and operatively coupled to motor 114. According to the preferred embodiment, blades 120 extend below outer wall 116 through a plane defined by a bottom edge of outer wall 116. During use, a user applies force to grout spreader 100. Blades 120 flex in response to this force so that edges of blades 120 in contact with the tiles move toward the plane defined by the bottom edge of outer wall 116.

In one embodiment, motor 114 may be battery powered or powered through a wired connection 125. In one embodiment, the plurality of blades 120 have a length 121, in which a ratio for length 121 to a maximum width 123 of grout spreader 100 is greater than 1 to 6. Maximum width 123 of grout spreader 100 is defined by width of base 106, but does not include a wired connection 125, such as a power cord. In other embodiments, plurality of blades 120 have a length in which the ratio for blade length to a maximum width of grout spreader 100 may be greater than 1 to 4, greater than 1 to 3, greater than 2 to 5, or other suitable ratios.

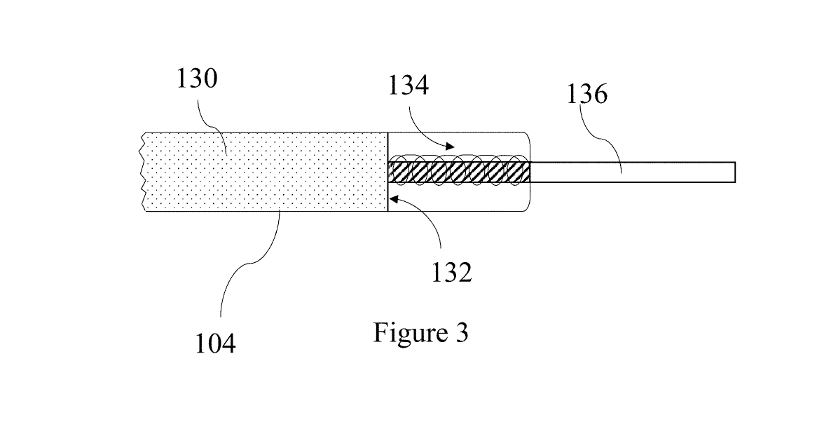

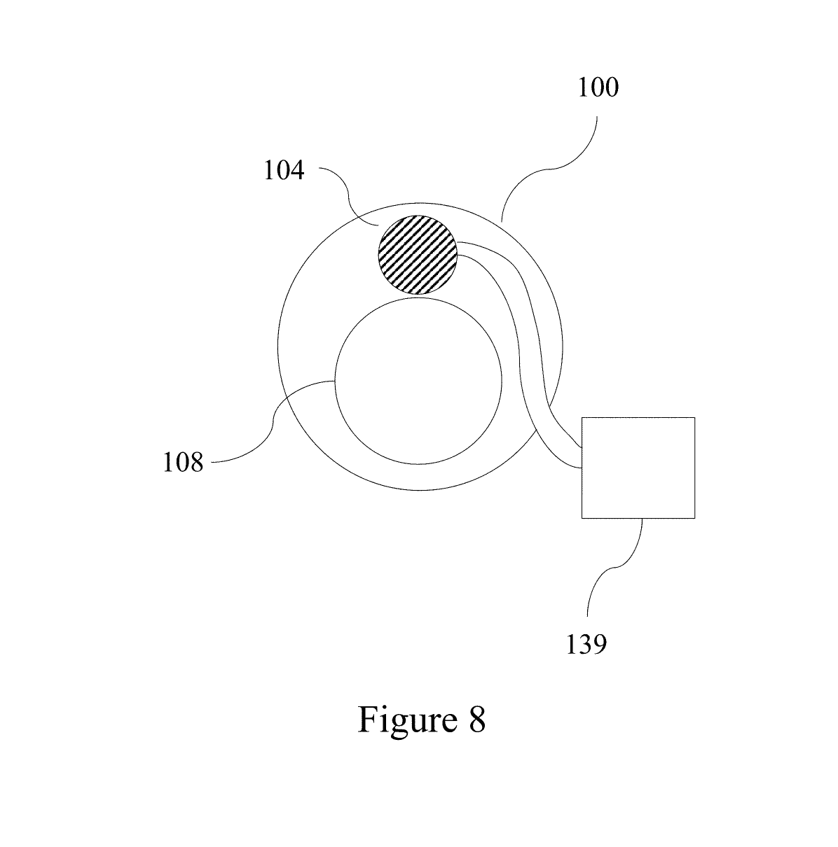

In the embodiment shown in FIG. 3, grout container 104 (shown with portions broken away) is filled with a grout 130. Grout 130 is forced out of grout container 104 into base 106 by a force exerted on a plunger 132 urged by a compressed spring 134 coiled around a rod 136. To pressurize grout container 104, exposed portion of rod 136 is pulled out of grout container 104 and then released. In other embodiments, grouting material 130 is forced out of grout container 104 to base 106 by a volume of pressurized air 139 that is coupled to grout container 104 (depicted in FIG. 8). Grout 130 is then fed into interior 128 of base 106 (not depicted). The grouting material enters interior 128 of base 106 and the movement of the plurality of blades 120 facilitates an even distribution of grouting material onto the desired surface. According to alterative embodiments, grout 130 may be pressurized by other means, such as a ratchet mechanism provided on common caulk guns, motorized screw driven plungers, etc.

In the embodiment shown in FIG. 1, grout container 104 takes the form of a long, straight, narrow tube oriented perpendicular to top wall 110 of base 106. In other embodiments, grout container 104 may be defined by any number of other lengths, curvatures, or widths. In additional embodiments of the present disclosure however, grout container 104 may be modified to allow grouting material 130 to be applied to a vertical or overhead surface (e.g., grout container 104 may be oriented parallel to top wall 110 of base 106, or at an angle greater than or less than 90 degrees relative to top wall 110 of base 106).

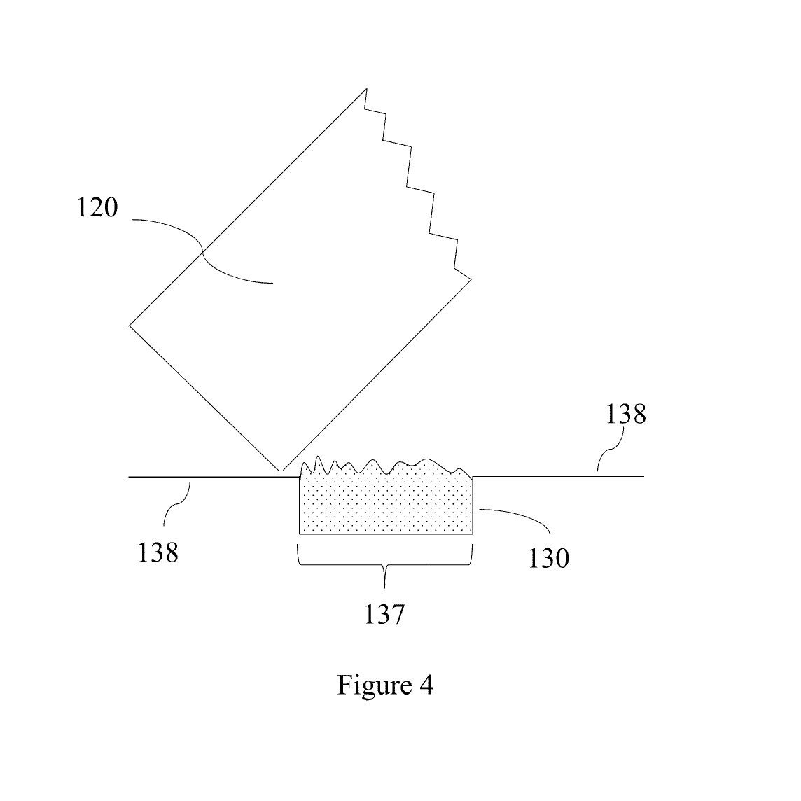

In the embodiment shown in FIG. 4, one of the plurality of blades 120 (with portions broken away) is pushing grouting material 130 into a gap 137 between two tiles 138. In one embodiment, plurality of blades 120 are in a combination of 45 degree angles and 90 degree angles, where plurality of blades 120 at 45 degree angles pushes grouting material 130 into gap 137 between two tiles 138 and plurality of blades 120 at 90 degree angles clears or wipes grouting material 130 from tiles 138. In other embodiments, plurality of blades 120 may be positioned at other angles, such as ranging between 45 degrees and 90 degrees.

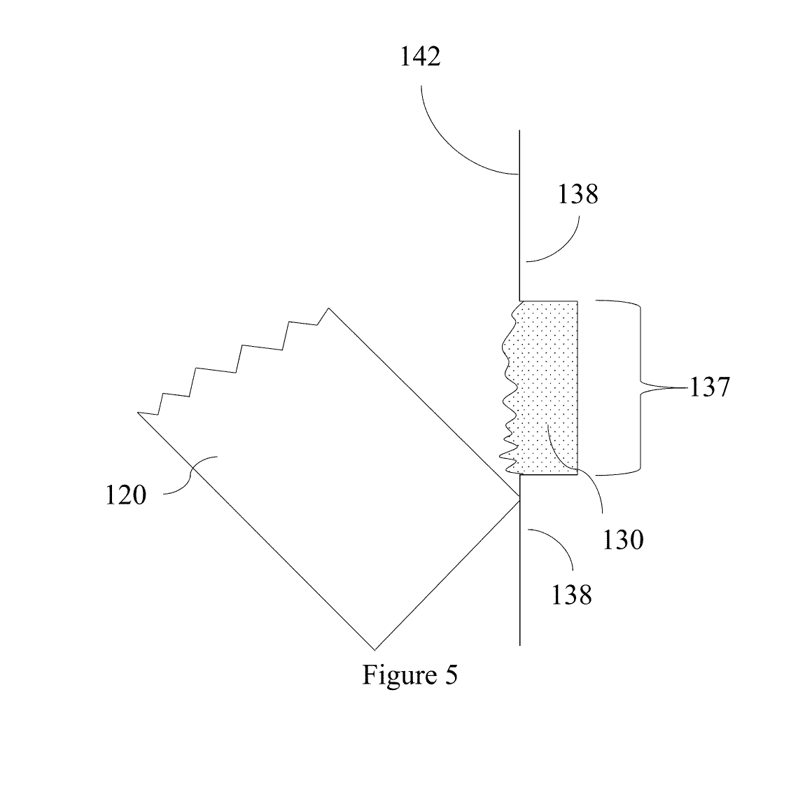

In the embodiment shown in FIG. 5, one of the plurality of blades 120 (with parts broken away) is pushing grouting material 130 into a gap 137 between two tiles 138 on a vertical wall 142.

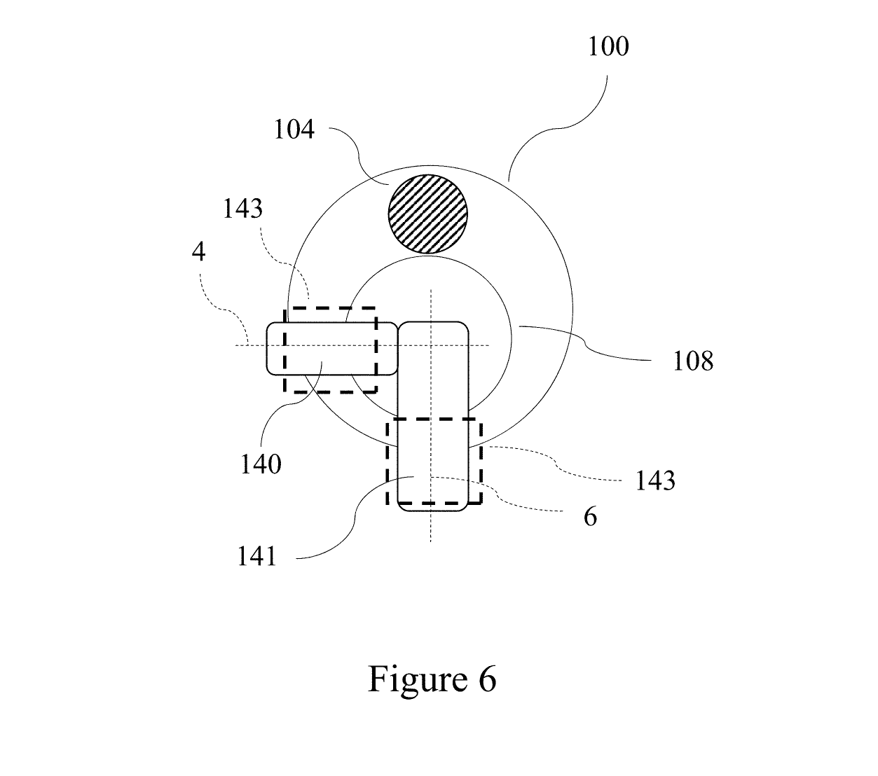

In the embodiment shown in FIG. 6, one embodiment of grout spreader 100 with grout container 104 is shown. A first handle 140 and a second handle 141 are coupled to drive assembly 108. A grip axis 4 of first handle 140 is transverse to a grip axis 6 of second handle 141. In FIG. 6, handle 140 takes the form of a long, straight, cylinder. In other embodiments, handle 140 may be defined by any number of lengths, shapes, or curvatures suitable for sustained gripping by a users' hands. Grip axes 4, 6 of first handle 140 and second handle 141 are adapted to be positioned between a thumb and fingers of a user (depicted diagrammatically as a hand 143). Grip axes of first handle 140 and second handle 141 are further adapted to extend in a medial-lateral direction relative to the palm of a user (depicted diagrammatically as a hand 143). Grip axes 4, 6 of first handle 140 and second handle 141 are positioned within a distance from base less than maximum width 123 of base 106.

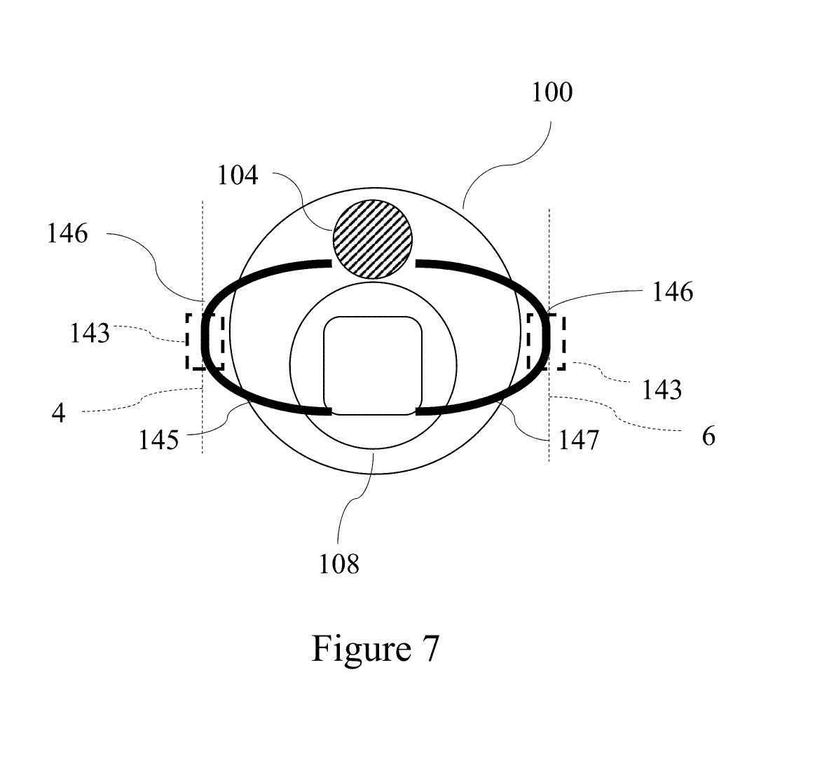

Referring to FIG. 7, another embodiment of grout spreader 100 is shown with first handle 145 and second handle 147. Handles 145, 147 have a curved middle section 146. In other embodiments, handles 145, 147 may be defined by any number of lengths, shapes, or curvatures. Grip axes 4, 6 of first handle 145 and second handle 147 are positioned within a distance from base less than maximum width 123 of base 106.

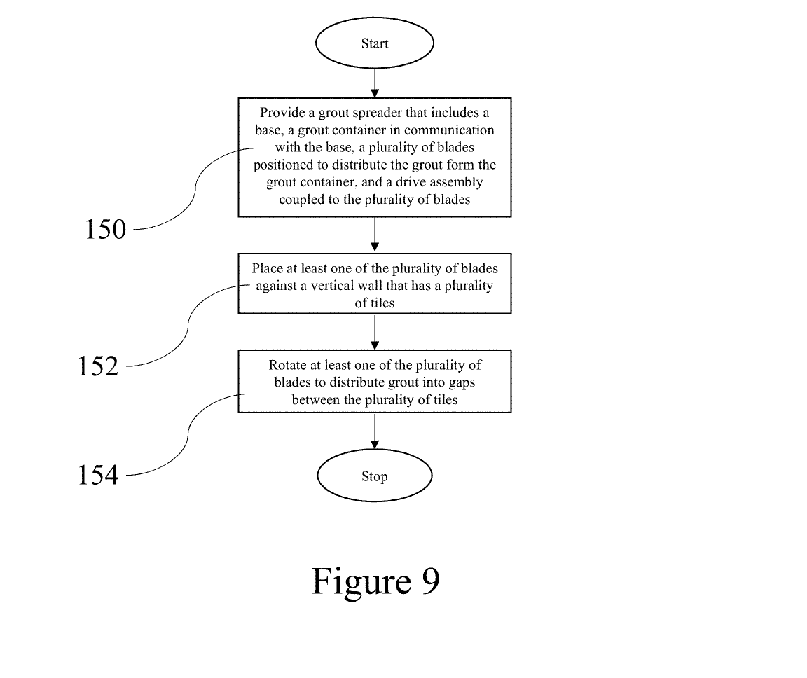

Referring to FIG. 9, a method for spreading grout on a vertical wall 142 is shown. The method includes providing 150 grout spreader 100. In some embodiments, providing step 150 may be carried out by the user. The method further includes placing 152 at least one of plurality of blades 120 against a vertical wall 142 that has a plurality of tiles 138. Finally, the method includes rotating 154 at least one of the plurality of blades 120 to distribute grout material 130 into gaps 136 between plurality of tiles 138. When necessary, container 104 is refilled, preferably with blades 120 on a horizontal surface, such as a floor or table top (not shown).

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practices in the art to which this disclosure pertains.

What is claimed is:

1. A grout spreader including
a base,
a grout container in communication with the base to provide grout to the base,
a plurality of blades positioned to distribute grout from the grout container into gaps between tiles, and
a drive assembly coupled to the plurality of blades, at least one of the plurality of blades having a length, a ratio of the length to a maximum width of the grout spreader being greater than 1 to 6.

2. The grout spreader of claim 1, wherein the ratio is greater than 1 to 4.

3. The grout spreader of claim 2, wherein the ratio is greater than 1 to 3.

4. The grout spreader of claim 3, wherein the ratio is greater than 2 to 5.

5. The grout spreader of claim 1, wherein the grout container provides grout to the base in a direction transverse to vertical,

6. The grout spreader of claim 5, further comprising an outer wall extending down from a bottom surface of the base, the base and the outer wall cooperating to define a grout receiving region, and the plurality of blades being positioned in the grout receiving region.

7. The grout spreader of claim 6, wherein a bottom edge of the outer wall defines a plane and the plurality of blades extends through the plane.

8. The grout spreader of claim 7, wherein a bottom edge of the plurality of blades is adapted to move toward the plane as force is applied to the grout spreader during distribution of grout to the tiles.

9. The grout spreader of claim 8, wherein at least one handle is adapted to be gripped by a user to control movement of the grout spreader, the handle having a grip axis adapted to be positioned between a thumb and fingers of a user grasping the handle, the grip axis adapted to extend in a medial lateral direction relative to a palm of a user grasping the handle, the grip axis being positioned within a distance from the base less than the maximum width of the base.

10. The grout spreader of claim 9, wherein the at least one handle is a first handle, further comprising a second handle adapted to be gripped by a user to control movement of the grout spreader, the second handle having a grip axis adapted to be positioned between a thumb and fingers of a user grasping the handle, the grip axis of the second handle being adapted to extend in a medial-lateral direction relative to a palm of a user grasping the second handle, and the grip axis of the second handle being positioned within a distance from the base less than the maximum width of the base.

11. The grout spreader of claim 10, wherein the grip axis of the first handle is transverse to the grip axis of the second handle.

12. The grout spreader of claim 10, wherein the grip axis of the first handle is parallel to the grip axis of the second handle.

13. A grout spreader including
a base,
a grout container in communication with the base that provides grout to the base, means for pressurizing grout provided to the base,
a plurality of blades positioned to distribute grout from the grout container, and
a drive assembly coupled to the plurality of blades.

14. The grout spreader of claim 14, wherein the pressure means include a spring and a plunger configured to force grout in the grout container to the base.

15. The grout spreader of claim 14, wherein the pressure means includes volume of pressurized air in communication with the grout container to force grout in the grout container to the base.

16-25. (canceled)

26. A method of spreading grout on a vertical wall using a grout spreader, the method including the steps of
providing a grout spreader including a base, a grout container in communication with the base, a plurality of blades positioned to distribute the grout from the grout container, and a drive assembly coupled to the plurality of blades
placing at least one of the plurality of blades against a vertical wall having a plurality of tiles, and
rotating at least one of the plurality of blades to distribute grout into gaps between the plurality of tiles.

27. The method of claim 26, further comprising a step of loading the grout container with grout with the blades positioned on a horizontal surface before the placing step.

28. The method of claim 26, wherein the grout spreader further includes means for pressurizing grout provided to the base.

29. The method of claim 26, wherein the grout spreader further includes at least one handle adapted to be gripped by a user to control movement of the grout spreader, the handle has a grip axis adapted to be positioned between a thumb and fingers of a user grasping the handle, the grip axis is adapted to extend in a medial lateral direction relative to a palm of a user grasping the handle, and the grip axis is positioned within a distance from the base less than the maximum width of the base.

30. The method of claim 26, wherein at least one of the plurality of blades having a length, a ratio of the length to a maximum width of the grout spreader being greater than 1 to 6.
